(19) United States
(12) Patent Application Publication
(10) Pub. No.: US 2006/0256804 A1
(43) Pub. Date: Nov. 16, 2006

(54) Call processing control apparatus, control method therefor and mobile communication control apparatus

(75) Inventors: Kouichi Kawarabata, Fukuoka (JP); Akira Hatae, Fukuoka (JP); Kazuhisa Matsumoto, Fukuoka (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/209,845

(22) Filed: Aug. 24, 2005

(30) Foreign Application Priority Data
May 16, 2005 (JP) 2005-143086

(51) Int. Cl. H04L 12/56

(52) U.S. Cl. 370/412

(57) ABSTRACT

The present invention provides a call processing control apparatus, comprising a plurality of processors for carrying out call control for communications; a shared memory, being shared by a plurality of the processors, for retaining call control data; a plurality of queues, being equipped between each of the processors and the shared memory, for accumulating, in time series, access request information from the processor to the shared memory; an accumulation speed measurement unit for measuring an accumulation speed which indicates an accumulation volume of the access request information in each of the queues per unit of time; and an arbitration unit for determining which of the queues the access request information is to be taken out of to carry out an access to the shared memory.

### BACKGROUND OF THE INVENTION

1. Field of the Invention

The present invention relates to a call processing control technique and in particular to a technique effectively applicable to a mobile communication control apparatus, et cetera, comprising an arbitration function which manages an execution sequence, by using a plurality of queues, of a plurality of access requests issued from a plurality of call control processors to a shared memory.

2. Description of the Related Art

In a mobile communication system, for example a mobile communication control apparatus intervening between a plurality of base stations and a public line comprises a call processing control apparatus for processing a large number of calls from mobile terminals and public lines under the management of each base station to interconnect between a mobile terminal and a public line.

In this case, a processing capacity of calls at the call processing control apparatus which manages a plurality of base stations concentratedly plays a major role in the system performance and operation stability. Accordingly, the call processing control apparatus carries out processing by a comprisal of a parallel processor system in order to carry out the call processing distributedly and effectively.

In this case, what is conceivable is a centralized memory type parallel processor system comprising a plurality of call control processors sharing a centralized memory which stores management information about calls, and an input queue between each of the call processors and the centralized memory for receiving an access request packet for the mobile communication control apparatus that handles call control. A common method to avoid competition in accessing the centralized memory is by accumulating access request packets, each of which is issued for each call processing by each call control processor independently, in the queues corresponding to the respective call control processors, and arbitrating a sequence of reading out of each queue by using an arbitration circuit.

Most adopted techniques for the arbitration circuit include a “Round Robin method” which reads a plurality of queues storing packets sequentially in a certain direction, a “WRR (Weighted Round Robin)”, an extension of the aforementioned method, which changes a weighting through a software setting or according to the volume of packets being accumulated in the queue to carry out priority control according to the weighting.

Another adopted method is a “back pressure method” for preventing an overflow of packets in a queue by monitoring a volume of packets accumulated in the queue as with the above described case, and issuing a packet stop request to a call control processor of a request issuer when an accumulated volume of packets exceeds a certain threshold value if a burst of traffic occurs so that call processing requests pour into a specific call control processor. This makes it possible to control a send-out rate of the packet sending party. The above described two methods are commonly used to control packet competition for a parallel processor system.

The above described conventional technique merely controls the go or no-go of packet issuance from the requesting call control processor based on whether or not an accumulated volume of packets in each queue exceeds a prescribed threshold value, and consequently does not consider monitoring a changing volume of packet traffic (i.e., packet increase volume) in a certain time interval.

Because of this, it is not possible to switch priorities, or issue a transmission stop instruction (i.e., back pressure) to a call control processor unless a packet volume in the queue reaches the prescribed threshold value even in the case of the queue accumulating volume rapidly increasing such as during burst traffic. This results in a delayed response if there is a rapid traffic increase possibly bringing forth degraded performance such as discarding a packet or stopping a transmission.

There is also another technical problem of excessive queue capacity for the purpose of preventing a packet overflowing the queue if some extent of burst traffic occurs, which is a countermeasure for the time lag between the occurrence of burst traffic and priority control or issuance of a transmission stop instruction.

There is yet another technical problem relating to the above described “Round Robin method” and WRR method in which installation of additional call control processors will increase the number of corresponding queues, making the wait time longer until the next reading cycle out of each queue and making the system unable to respond to rapid traffic increase.

The mobile communication control apparatus is not allowed to discard or stop sending call processing request packets for handling call processing. Rapid burst traffic, however, may occur at the time of a disaster occurring or during phone reservation for a very popular ticket. Current systems are faced with an inability to cope with such a burst traffic problem of performance degradation in equipment, or downed systems, or a failure to function as a communication infrastructure.

In the meantime, the patent document 1 listed below has disclosed a technique for determining a cyclic priority order based on the number of access requests to each device and data transmission volume in an arbitration of bus access rights to a PCI bus of a plurality of devices sharing the PCI bus. The processing for access requests from the respective devices, however, determines access rights by a mechanism of bus timeout & retry, and therefore cannot be applied to a usage, such as a call processing request, in which discarding an access request may bring forth a critical result such as call interruption or a wrong fee being charged.

The patent document 2 has disclosed a technique for counting the number of ATM cells outputted from an ATM cell buffer in units of VCs (virtual connection) at a certain interval to determine the count number as an output minimum band in deciding the number of accumulated ATM cells for the next interval. The ATM technique, however discards cells at busy times by design, and therefore cannot be applied to a usage in which discarding of packets for call control may bring forth a critical result as noted above.

The patent document 3 has disclosed a technique for judging where to allocate a new packet by using both prediction of the packet to be inputted in the near future by utilizing packet assembly positional information gleaned from packets that have already been processed and a volume of currently processed packets (i.e., the number of packets contained in the queue) in order to make parallelized packet processing units capable of leveling loads in a high accuracy in communication equipment for receiving a multiplexed frame which has multiplexed a plurality of different communication information packets to judge the destination of frame transmission for each frame.

The case put forth by the patent document 3, however, is a control for a priority order in allocating a packet to the queues and not one for taking a packet out thereof, and therefore there is no guarantee of a queue with a large volume of accumulated packets being put in first priority for processing.

The patent document 4 has tried to make an execution control apparatus, which controls time division processing by a plurality of CPUs, capable of carrying out not only real time processing for a task brought about by a plurality of causes, but also high speed processing for a task with a large load fluctuation, through registering task resources by causes, estimating a load for each CPU based on a coming interval of the aforementioned cause and the average execution time of each CPU for the task, and accordingly changing the execution rate thereof.

The case put forth by the patent document 4, however, is of a control for allocating the tasks contained by one queue buffer to a plurality of CPUs, and not for accomplishing effective processing of reading out of the plurality of queues.

[Patent document 1] Japanese laid-open patent application publication No. 2000-148670

[Patent document 2] Japanese laid-open patent application publication No. 2000-332793

[Patent document 3] Japanese laid-open patent application publication No. 2004-235732

[Patent document 4] Japanese laid-open patent application publication No. 07-160650

### SUMMARY OF THE INVENTION

A purpose of the present invention is to provide a call processing control technique capable of carrying out accurate call processing without bringing about degraded performance such as discarding calls, stopping processing.

Another purpose of the present invention is to provide a call processing control technique capable of responding to a rapid increase in the number of call processes without making the capacity of queues unnecessarily large for shared processing of calls by a plurality of processors.

Yet another purpose of the present invention is to provide a call processing control technique capable of responding to a rapid increase in the number of call processes even in the case of a large number of queues existing for shared processing of calls by a plurality of processors.

A first aspect of the present invention is to provide a call processing control apparatus comprising: a plurality of processors for carrying out a call control for communications; a shared memory, being shared by a plurality of the processors, for retaining a call control data; a plurality of queues, being equipped between each of the processors and the shared memory, for accumulating, in time series, access request information from the processor to the shared memory; an accumulation speed measurement unit for measuring an accumulation speed which indicates an accumulation volume of the access request information for each of the queues per unit of time; and an arbitration unit for determining which of the queues the access request information is to be taken out of to carry out an access to the shared memory.

A second aspect of the present invention is to provide a control method for a call processing control apparatus including a plurality of processors for carrying out call control for communications; a shared memory, being shared by a plurality of the processors, for retaining call control data; and a plurality of queues, being equipped between each of the processors and the shared memory, for accumulating, in time series, access request information from the processor to the shared memory; comprising the first process of measuring an accumulation speed which indicates an accumulation volume of the access request information for each of the queues per unit of time; and the second process of taking the access request information out of each of queue to carry out an access to the shared memory in a descending sequence of the accumulation speed.

A third aspect of the present invention is to provide a mobile communication control apparatus including a first line terminal unit which is connected to a plurality of base stations for carrying out communications with mobile terminals, a second line terminal unit which is connected to a public line, and a call processing control unit, which intervenes between the first and second line terminal units, for carrying out call control, wherein the call processing control unit comprises a plurality of processors for carrying out call control for communications; a shared memory, being shared by a plurality of the processors, for retaining call control data; a plurality of queues, being equipped between each of the processors and the shared memory, for accumulating, in time series, access request information from the processor to the shared memory; an accumulation speed measurement unit for measuring an accumulation speed which indicates an accumulation volume of the access request information in each of the queues per unit of time; and an arbitration unit for determining which of the queues the access request information is to be taken out of to carry out an access to the shared memory based on the accumulation speed at each of the queues.

### BRIEF DESCRIPTION OF THE DRAWINGS

FIG. 1A is a block diagram showing an example of an internal comprisal of a call processing control apparatus as an embodiment of the present invention;

FIG. 1B is a block diagram showing another example of an internal comprisal of a call processing control apparatus as an embodiment of the present invention;

FIG. 2 is a conceptual diagram exemplifying a comprisal of a mobile communication system using a call processing control method as an embodiment of the present invention;

FIG. 3 is a conceptual diagram exemplifying the structure of an access request packet used within a mobile communication control apparatus as an embodiment of the present invention;

FIG. 4 is a block diagram exemplifying an internal comprisal and operation of a call processing control apparatus comprised by a mobile communication control apparatus as an embodiment of the present invention;

FIG. 5 is a block diagram exemplifying an internal comprisal of an accumulation speed calculation unit comprised by a call processing control apparatus as an embodiment of the present invention;

FIG. 6A is a flow chart exemplifying an operation of an accumulation speed calculation unit comprised by a call processing control apparatus as an embodiment of the present invention;

FIG. 6B is a flow chart exemplifying an operation of an accumulation speed calculation unit comprised by a call processing control apparatus as an embodiment of the present invention;

FIG. 7 is a block diagram exemplifying an internal comprisal of a queue management unit comprised by a call processing control apparatus as an embodiment of the present invention;

FIG. 8 is a flow chart exemplifying an operation of a queue management unit comprised by a call processing control apparatus as an embodiment of the present invention;

FIG. 9 is a flow chart exemplifying an operation of a call processing control apparatus as an embodiment of the present invention;

FIG. 10 is a diagram exemplifying the occurrence of access request packets in a call processing control apparatus as an embodiment of the present invention;

FIG. 11 is a diagram showing a transition of the number of packets in each queue in the case of processing access request packets occurring as exemplified by FIG. 10 by the conventional Round Robin method; and

FIG. 12 is a diagram showing a transition of the number of packets in each queue in the case of processing access request packets occurring as exemplified by FIG. 10 by a call processing control apparatus as an embodiment of the present invention.

### DESCRIPTION OF THE PREFERRED EMBODIMENTS

The following is a detailed description of the preferred embodiment of the present invention while referring to the accompanying drawings.

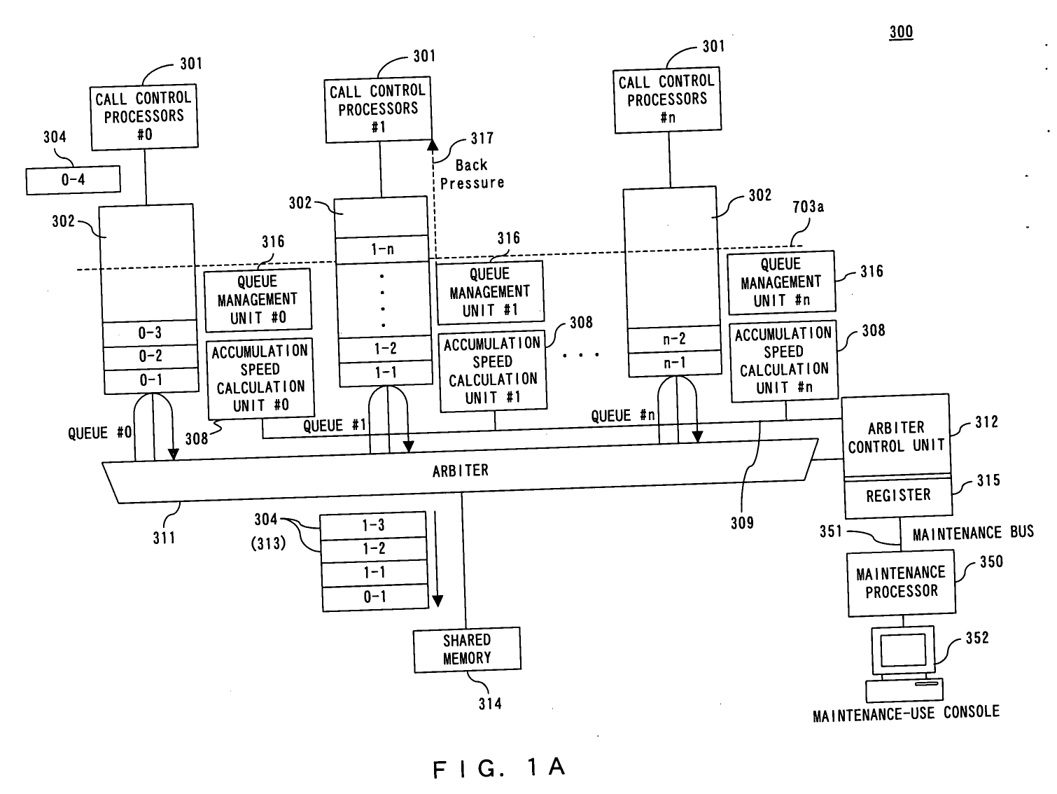

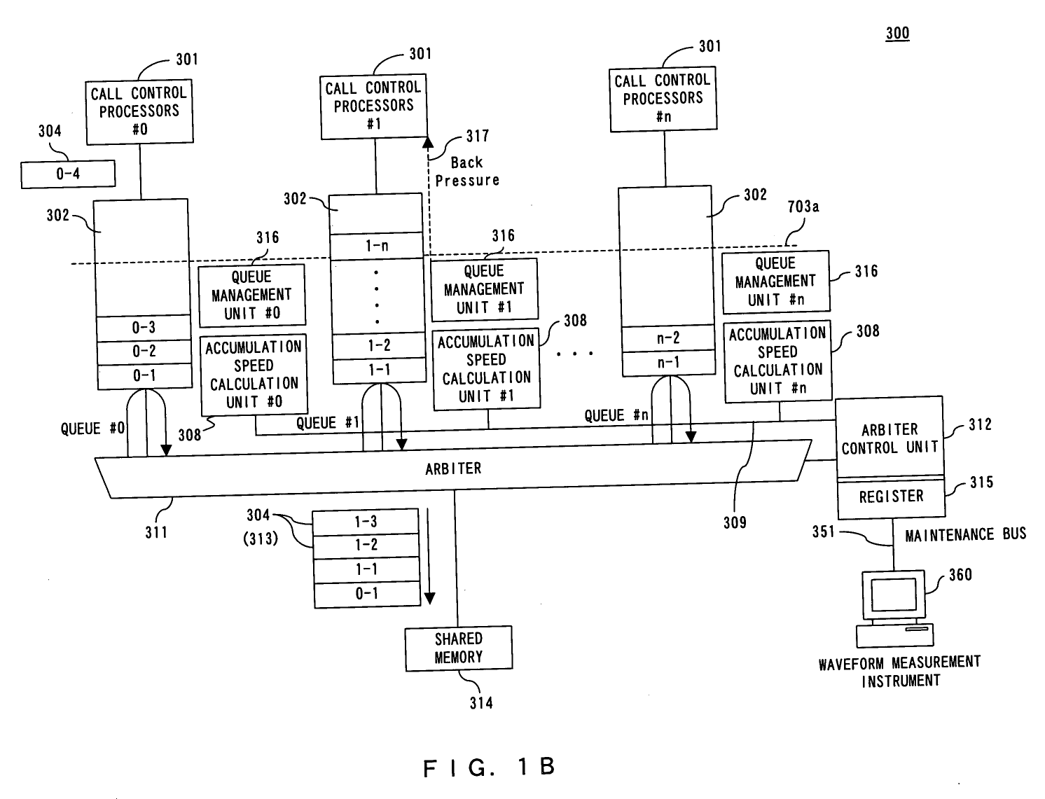

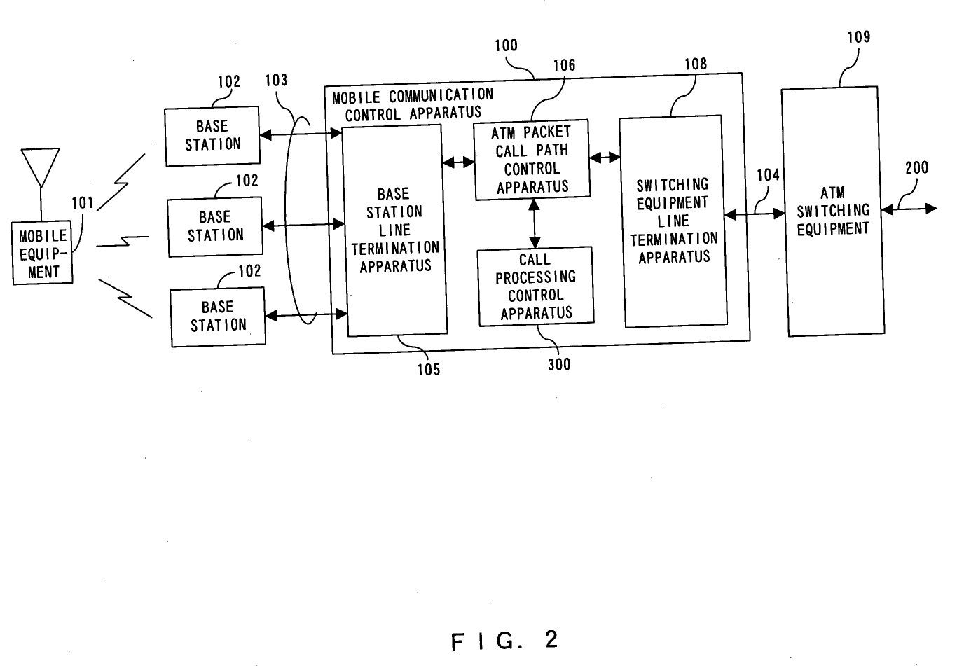

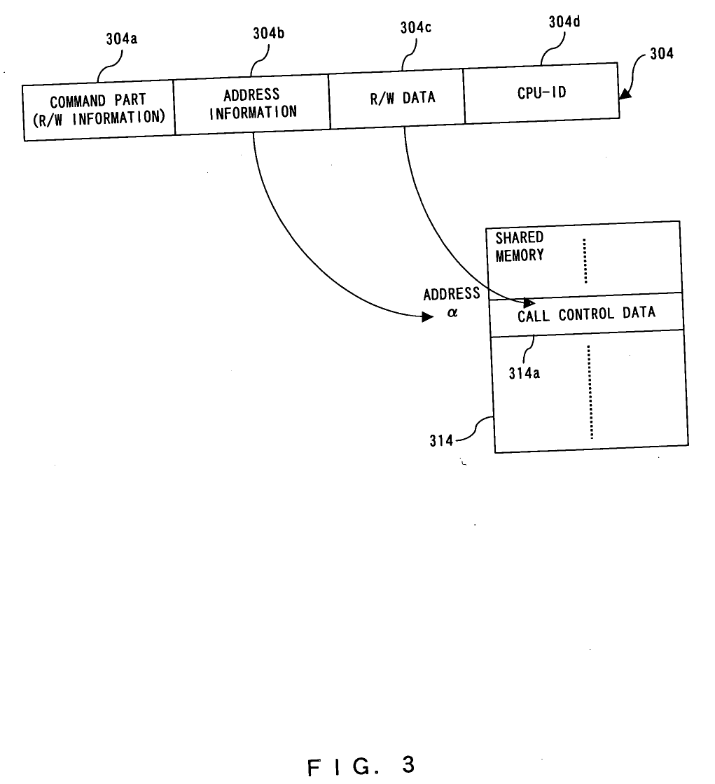

FIGS. 1A and 1B are each block diagrams showing an example of an internal comprisal of a call processing control apparatus according to an embodiment of the present invention; FIG. 2 is a conceptual diagram exemplifying a comprisal of a mobile communication system using a call processing control method according to the present embodiment; and FIG. 3 is a conceptual diagram exemplifying the structure of information used within the mobile communication control apparatus which comprises the call processing control apparatus according to the present embodiment.

As exemplified by FIG. 2, a mobile communication system according to the present embodiment includes a plurality of base stations 102 for carrying out wireless communications with a plurality of mobile equipment 101 and a mobile communication control apparatus 100 which intervenes between the plurality of base stations 102 and a public line switching system such as ATM switching equipment 109 that controls an ATM (asynchronous transfer mode) communication. The ATM switching equipment 109 is connected to a public network 200.

The mobile communication control apparatus 100 controls each of the plurality of base stations 102, the transmission & reception & connection, et cetera, for each mobile equipment 101, and carries out protocol conversion of user signals between the base station 102 and ATM switching equipment 109 which is on a stationary network.

The mobile communication control apparatus 100 includes a base station line termination apparatus 105, an ATM packet speech path control apparatus 106, a switching equipment line termination apparatus 108 and a call processing control apparatus 300.

The base station line termination apparatus 105, being connected to each base station 102 by way of a base station line 103, carries out termination of the base station line 103. The switching equipment line termination apparatus 108, being connected to the ATM switching equipment 109 by way of a switching equipment line 104, carries out termination thereof.

The ATM packet speech path control apparatus 106 handles the call processing between the mobile equipment 101 by way of a plurality of base stations 102, and between mobile equipment 101 and a public line, over to the call processing control apparatus 300. Meanwhile, the ATM packet speech path control apparatus 106 converts transmission information incoming from mobile equipment 101 (through a base station 102) into an ATM cell and conversely an ATM cell incoming from the ATM switching equipment 109 into transmission information for the mobile equipment 101 (through a base station 102) for a speech path between each mobile equipment 101 and an ATM switching equipment 109 which has been established through call processing by the call processing control apparatus 300.

The call processing control apparatus 300 carries out call processing control (i.e., incoming & outgoing call connection control) and termination processing of the communication protocol for the base station line 103 as well as the switching equipment line 104.

As exemplified by FIG. 1A, the call processing control apparatus 300 according to the present embodiment includes a plurality of call control processors 301 (#0 through #n), a plurality of queues 302 (#0 through #n), an arbiter 311 and an arbiter control unit 312, and a shared memory 314.

The shared memory 314, being shared by the plurality of call control processors 301, stores call control data 314a used for call processing carried out by each of the call control processors 301.

Each of the plurality of queues 302 is installed in correspondence to each of the plurality of call control processors 301 to accumulate, in time sequence, access request packets 304 (i.e., access request information) issued at the time of access request from the plurality of call control processors 301 to the shared memory 314.

As exemplified by FIG. 3, the access request packet 304 is structured by a command part 304a, address information 304b, R/W data 304c and CPU-ID 304d.

The command part 304a indicates a category of access, such as read/write, to the shared memory 314 by the call control processor 301. The address information 304b is an address of the access area on the shared memory 314. The R/W data 304c is call control data which is read out of, or written into, the shared memory 314. The CPU-ID 304d is identifier information, such as a processor ID, about the call control processor 301 which has issued the aforementioned access request packet 304.

The arbiter 311 takes an access request packet 304, as a readout packet 313, out of each queue in a prescribed sequence to carry out an access to the shared memory 314 by using each of the access request packets 304, based on an instruction (i.e., a later described readout queue number 318a and readout instruction 318b) from the arbiter control unit 312.

Each queue 302 is individually furnished with an accumulation speed calculation unit 308 and queue management unit 316.

Each accumulation speed calculation unit 308 measures an accumulation volume of the access request packets 304 per unit of time at the corresponding queue 302 to input to the arbiter control unit 312 as an accumulation speed 309.

The queue management unit 316 measures an accumulation volume of the access request packets 304 at the corresponding queue 302 to input to the arbiter control unit 312 as a queue accumulation volume 310.

And the arbiter control unit 312 controls the readout sequence of access request packets 304 from each of the plurality of queues 302 under the priority control of the arbiter 311.

The present embodiment is configured so that the arbiter control unit 312 determines the queue 302 of which the arbiter 311 reads out the access request packet 304 based on the information about the accumulation speed 309 and queue accumulation volume 310 at each queue 302.

That is, the arbiter control unit 312 recognizes a packet accumulation speed at each queue 302 by the information about the accumulation speed 309 (i.e., the number of packets stored in each queue 302 increasing per unit of time) obtained from the accumulation speed calculation unit 308 which is equipped to each queue 302. And the arbiter control unit 312 compares the values of the accumulation speeds 309 recognized for the individual queues 302, assigns a priority sequence by accumulation speed 309 in descending order and controls selection of queue 302 by the arbiter 311 accordingly. The arbiter 311 reads an access request packet 304 out of a queue 302 with a higher accumulation speed 309, while leaving a queue 302 with a lower accumulation speed 309 unread. This control lightens the load on the queue which has seen a rapid increase in access request packets 304.

Here, if the accumulation speeds 309 of access request packets 304 at the individual queues 302 are equal with one another, the arbiter control unit 312 puts priority on a queue 302 with a large volume of access request packets 304 in reading an access request packet 304 based on the information about the queue accumulation volume 310 obtained from the respective queue management units 316.

The information of the operating status, such as the above described accumulation speed 309, queue accumulation volume 310, readout queue number, et cetera, for each queue 302 can be transmitted to the outside by way of a register 315 comprised by the arbiter control unit 312.

As exemplified by FIG. 1A, the present embodiment configures itself so that the register 315 is connected by an external maintenance processor 350 through a maintenance bus 351, and a maintenance-use console 352 is further connected to the maintenance processor 350.

The maintenance processor 350 collects information of the operating status, such as accumulation speed 309, queue accumulation volume 310, readout queue number, et cetera, for each queue 302 by way of the register 315, and the collected information is then provided visually to a system manager, et al., through the maintenance-use console 352, thereby making it possible to monitor it, supervise the status of predicted concentration of loads from the upper hierarchy maintenance-use console 352 and utilize the collected information for fault analysis purposes.

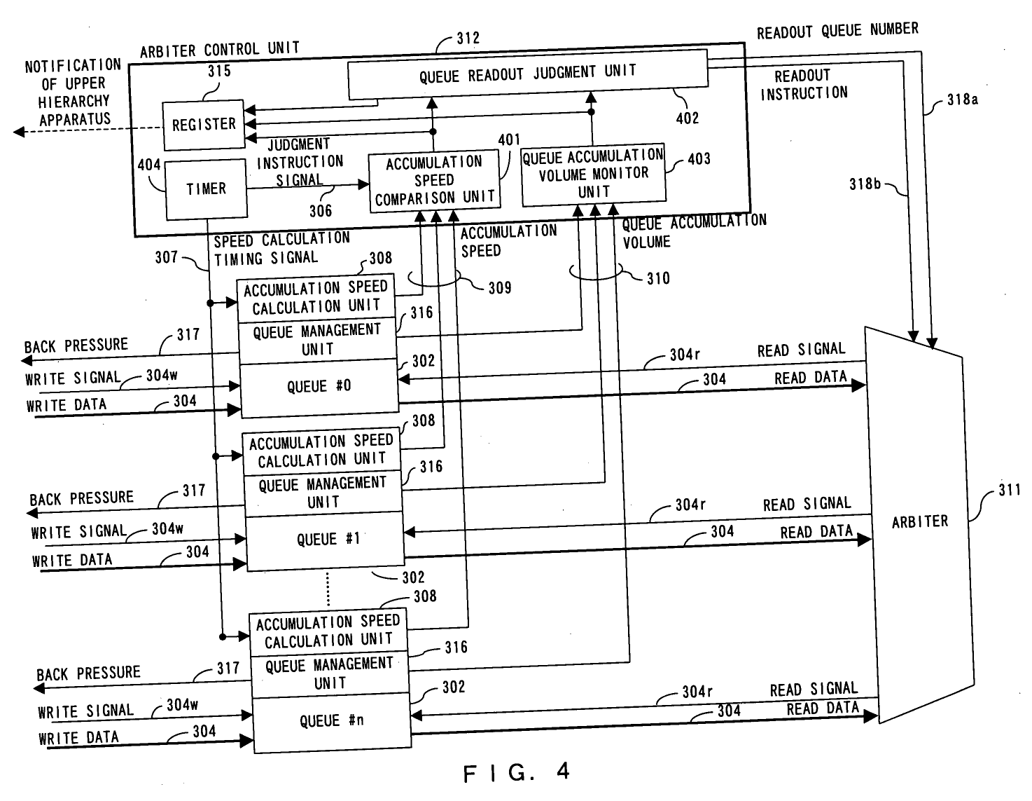

In the meantime, as exemplified by FIG. 1B, it is also possible to observe the information on the operating status, such as an accumulation speed 309, queue accumulation volume 310, readout queue number, et cetera, for each queue 302 collected by the arbiter control unit 312 as a waveform in a judgment instruction signal 306 (Refer to FIG. 4 the following description) by connecting a waveform measurement instrument 360 to the register 315.

The next description is of an example of an internal comprisal and operation of the arbiter control unit 312 while referring to FIG. 4. The arbiter control unit 312 comprises an accumulation speed comparison unit 401, a queue readout judgment unit 402, a queue accumulation volume monitor unit 403 and a timer 404.

As the queue 302 receives a write signal 304w for storing an access request packet 304 received from the corresponding call control processor 301, the accumulation speed calculation unit 308 counts the number of the aforementioned access request packets 304 received and calculates accumulation speeds 309 of the access request packets 304 at the respective queues 302 synchronously with the timing pulse of the speed calculation timing signal 307 outputted from the timer 404 comprised by the arbiter control unit 312. The accumulation speeds 309 at the respective queues 302 outputted from the respective accumulation speed calculation units 308 are summed by the accumulation speed comparison unit 401 comprised by the arbiter control unit 312. The accumulation speed comparison unit 401 compares the accumulation speeds 309 at the respective queues 302 synchronously with a timing pulse of the judgment instruction signal 306 provided by the timer 404.

Based on a comparison result of the accumulation speed comparison unit 401, the queue readout judgment unit 402 comprised by the arbiter control unit 312 assigns a sequence number to each queue 302 so as to read an access request packet 304 out thereof beginning from the queue 302 with the highest accumulation speed 309, accordingly notifies the arbiter 311 of the number for a queue 302 to be read (i.e., queue #0 through #n) as a readout queue number 318a, and initiates a readout by outputting a readout instruction 318b.

The arbiter 311 transmits a read signal 304r to the queue 302 indicated by the readout queue number 318a and receives read data (i.e., an access request packet 304) as a readout packet 313.

Meanwhile, the queue management unit 316 furnished for each queue 302 monitors the queue accumulation volume 310 for indicating the number of access request packets 304 retained by each queue 302. The information about the queue accumulation volume 310 is summed by the queue accumulation volume monitor unit 403 comprised by the arbiter control unit 312. The queue readout judgment unit 402 controls the arbiter 311 so as to read an access request packet 304 out of the queue 302 with the larger queue accumulation volume 310 first if the values of the accumulation speed 309 at the individual queues 302 are the same.

The arbiter control unit 312 notifies an external apparatus, such as an external maintenance processor 350, waveform measurement instrument 360, et cetera, of the accumulation speed 309 regarding each queue 302, queue accumulation volume 310 and readout queue number 318a by way of the register 315, which has been described above.

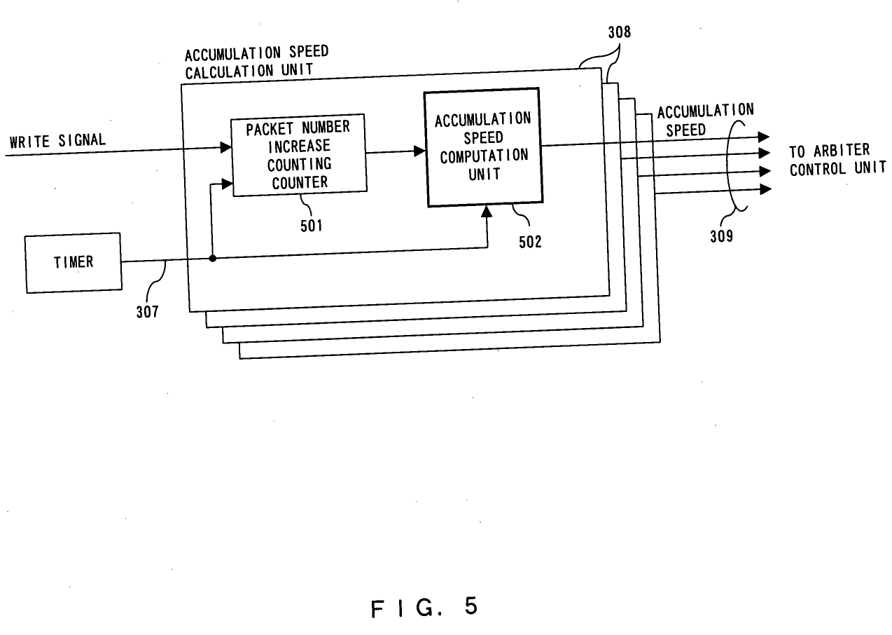

The next description is of an example of an internal comprisal of the accumulation speed calculation unit 308 while referring to FIG. 5.

The accumulation speed calculation unit 308 comprises a packet number increase counting counter 501 and an accumulation speed computation unit 502. The accumulation speed calculation unit 308 calculates an accumulation speed of the access request packets 304 at the corresponding queues 302 to notify the accumulation speed comparison unit 401 comprised by the arbiter control unit 312 of it as the accumulation speed 309.

The packet number increase counting counter 501 counts the number of received write signals 304w in association with transferring the access request packets 304 from the call control processors 301 to the queues 302. And, having received a speed calculation timing signal 307 from the timer 404, the packet number increase counting counter 501 notifies the accumulation speed computation unit 502 of the count Value of the number of received write signals 304w, followed by initializing the packet number increase counting counter 501.

The accumulation speed computation unit 502 receives the count number of write signals 304w from the packet number increase counting counter 501 and also notifies the arbiter control unit 312 of the value of the accumulation speed 309 when receiving a speed calculation timing signal 307 from the timer 404.

That is, the counter value of the packet number increase counting counter 501 indicates an increasing volume of access request packets 304 at the queue 302 per unit of time equaling to one interval of the speed calculation timing signal 307, so that the accumulation speed computation unit 502 outputs the increasing volume of access request packets 304 per unit of time to the arbiter control unit 312 as the accumulation speed 309.

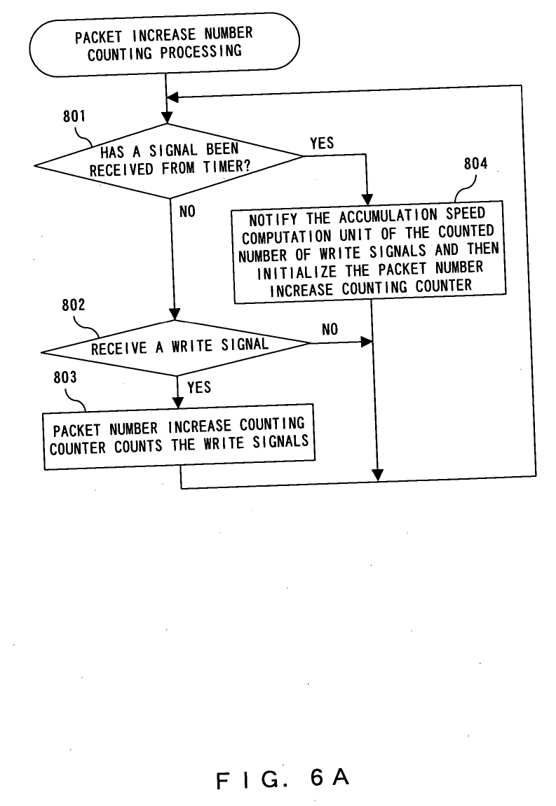

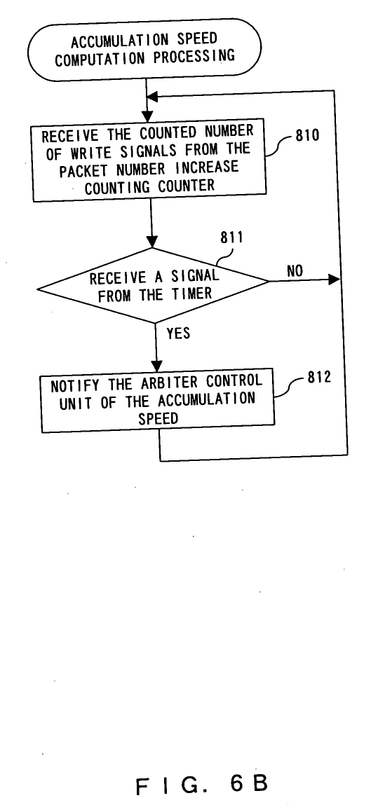

The next description is of the above described processing by the accumulation speed calculation unit 308 in reference to the flow charts shown by FIGS. 6A and 6B.

As shown by FIG. 6A, the packet number increase counting counter 501 judges a presence or absence of input of a speed calculation timing signal 307 from the timer 404 (step 801) and, if it is absent, then judges the presence or absence of a received write signal 304w in association with an incoming access request packet 304 from a call control processor 301 (step 802) and, if received, counts the number of write signals 304w (step 803), followed by returning to the step 801. On the other hand, if a write signal 304w is not received in the step 802, the processing returns to the step 801.

If detecting a speed calculation timing signal 307 in the above noted step 801, the processing outputs the count value of the packet number increase counting counter 501 to the accumulation speed computation unit 502 and then initialize the aforementioned packet number increase counting counter 501 to zero (“0”) (step 804), followed by returning to the step 801.

Meanwhile, the accumulation speed computation unit 502, having received a count value from the packet number increase counting counter 501 (step 810), judges a presence or absence of a received speed calculation timing signal 307 from the timer 404 (step 811) and, if received, outputs the aforementioned counter value to the arbiter control unit 312 as the accumulation speed 309 (step 812), followed by returning to the step 810.

If a speed calculation timing signal 307 is not received in the step 811, the processing returns to the step 810.

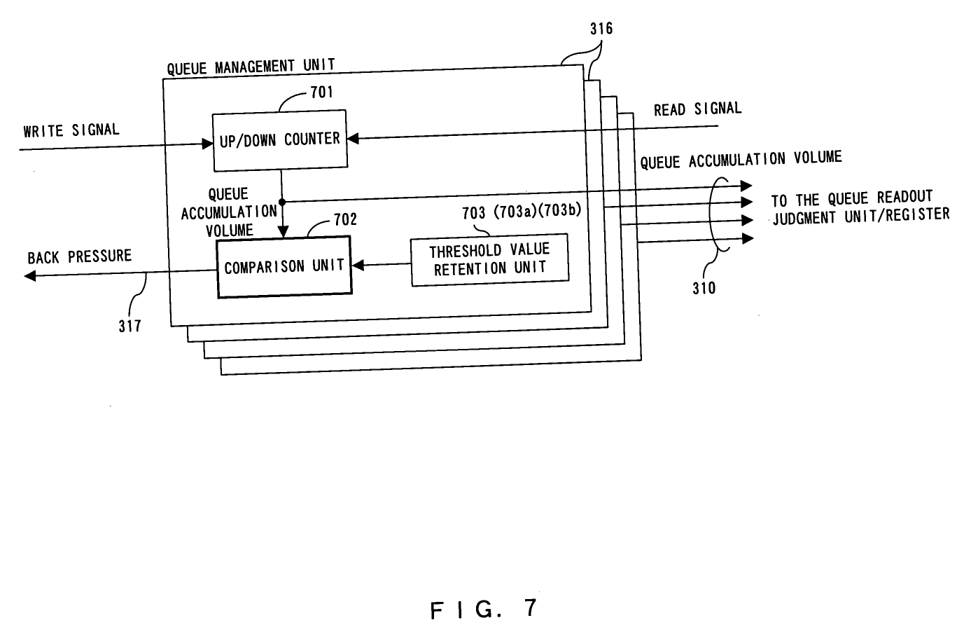

The next description is of an example of an internal comprisal and operation of the queue management unit 316 while referring to FIG. 7. The queue management unit 316 comprises an up/down counter 701, a comparison unit 702, and a threshold value retention unit 703. The threshold value retention unit 703 is set with two threshold values, i.e., a setup threshold value 703a for determining an occurrence trigger for a back pressure signal 317 and a cancel threshold value 703b for determining a cancellation trigger therefor.

The up/down counter 701 counts up when receiving a write signal 304w in association with transmitting an access request packet 304 from a call control processor 301 to a queue 302, while counting down when receiving a read signal 304r in association with taking an access request packet 304 out of a queue 302 to the arbiter 311. The comparison unit 702 compares a queue accumulation volume 310 with the setup threshold value 703a. If the queue accumulation volume 310 exceeds the setup threshold value 703a, the comparison unit 702 outputs a back pressure signal 317 to the call control processor 301, so as to suppress a transfer of access request packet 304 to the queue 302 therefrom.

If the queue accumulation volume 310 is smaller than the cancel threshold value 703b, the comparison unit 702 stops output of the back pressure signal 317 to the call control processor 301 so as to enable a transfer of access request packets 304 to the queue 302 therefrom.

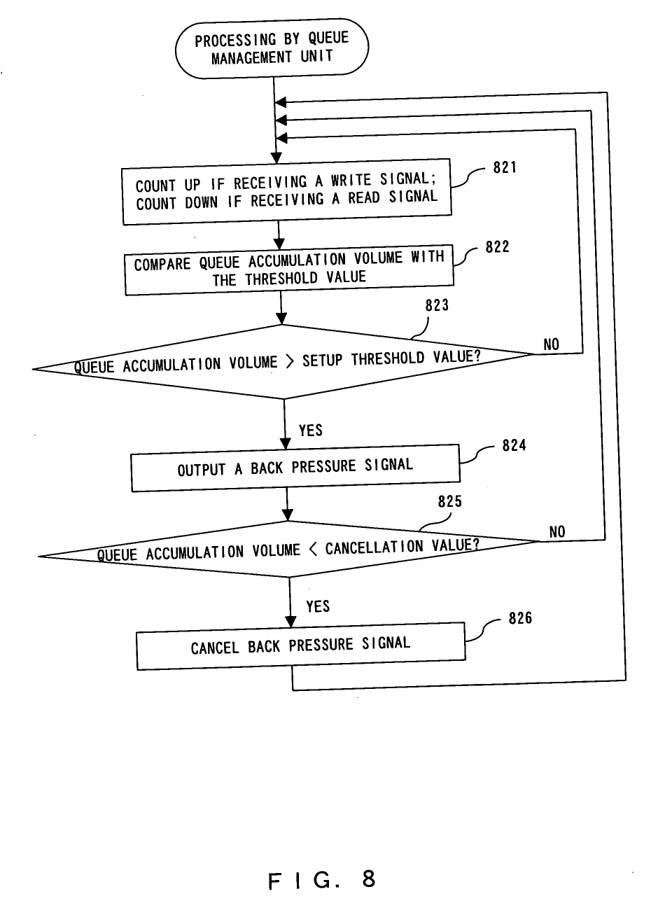

The next description is of the processing at the queue management unit 316 while referring to FIG. 8.

An input of write signal 304w or read signal 304r to the queue 302 makes the up/down counter 701 count up or down, respectively (step 821), followed by comparison of the count value of the up/down counter 701 (i.e., queue accumulation volume 310) with the two threshold values set up by the threshold value retention unit 703 (step 822).

Then, whether or not the queue accumulation volume 310 has exceeded the setup threshold value 703a (step 823) is judged and, if exceeded, a back pressure signal 317 is output to the call control processor 301 (step 824).

Further, whether or not the queue accumulation volume 310 has fallen below the cancel threshold value 703b (step 825) is judged and, if has fallen below, the output of the back pressure signal 317 to the call control processor 301 is stopped (step 826), followed by returning to the step 821.

On the other hand, if the queue accumulation volume 310 is judged not to have exceeded the setup threshold value 703a in the above described step 823, the processing goes back to the step 821. Likewise, if the queue accumulation volume 310 is judged not to have fallen below the cancel threshold value 703b in the step 825, the processing returns to the step 821.

The next description is of the arbiter 311 outputting a read signal 304r to each queue 302, that is, a sequence control for reading an access request packet 304 out of each queue 302. The arbiter control unit 312, after receiving a startup signal (i.e., judgment instruction signal 306) from the timer 404, compares accumulation speeds 309 at the individual queues 302 if the queue accumulation volume 310 is larger than zero (“0”) according to the monitoring by the queue accumulation volume monitor unit 403. If there is a difference in the accumulation speeds 309, selects a queue with the highest of the accumulation speeds 309 and notifies the arbiter 311 of the readout queue number 318a and readout instruction 318b. The arbiter 311 outputs the read signal 304r of the queue number corresponding to the accumulation speed 309, to the queue 302 which is the readout target.

If there are queues 302 with the same accumulation speed 309, compares the queue accumulation volumes 310 of the respective queues 302. If there is a difference in queue accumulation volumes 310, selects the queue 302 with the largest queue accumulation volume 310 first and the arbiter 311 outputs a read signal 304r to the selected queue 302. If there is a plurality of queues 302 with both the accumulation speed 309 and queue accumulation volume 310 being the same, outputs a read signal 304r to a queue 302 selected by the Round Robin or WRR method.

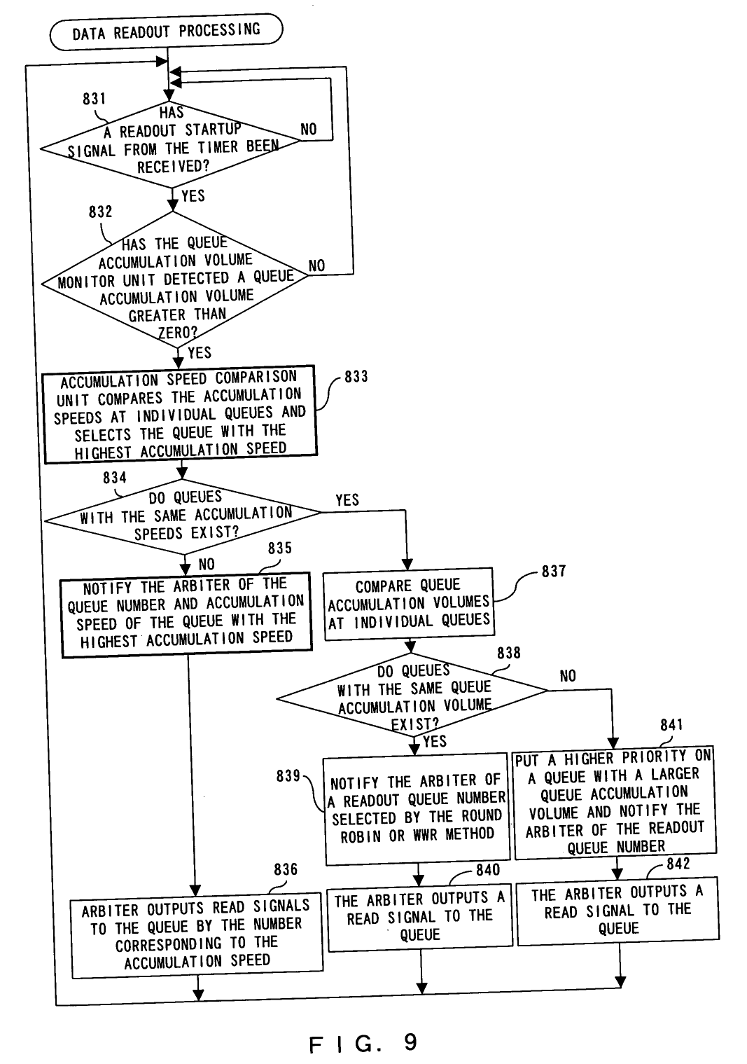

FIG. 9 is a flow chart exemplifying an operation of the arbiter control unit 312 controlling the arbiter 311.

First, the queue readout judgment unit 402 obtains a trigger when the timer outputs a judgment instruction signal 306 (i.e., readout startup signal) to the accumulation speed comparison unit 401 (step 831) to let the queue accumulation volume monitor unit 403 judge whether or not the queue accumulation volume 310 in each queue 302 is zero, that is, the queue 302 is empty (step 832). And, if the queue is not empty, the queue readout judgment unit 402 first lets the accumulation speed comparison unit 401 select the queue 302 with the highest accumulation speed 309 (step 833). In this event, the queue readout judgment unit 402 judges whether or not there are queues 302 with the same accumulation speed 309 (step 834) and, if there are not, notifies the arbiter 311 of the queue number and accumulation speed 309 of a queue 302 with the highest accumulation speed 309 (step 835). The arbiter 311 outputs read signals 304r by the number corresponding to the accumulation speed 309 to the queue 302 as the subject of reading, reads the access request packet 304 within the aforementioned queue 302, takes it out thereof and carries out an access to the shared memory 314 (step 836).

If a plurality of queues 302 with the same accumulation speed 309 are judged to exist in the above described step 834, the queue readout judgment unit 402 refers to the queue accumulation volume monitor unit 403 and compares the values of queue accumulation volumes 310 in the individual queues 302 (step 837) to judge the presence or absence of queues 302 with the same queue accumulation volume 310 (step 838).

And, if there is a plurality of queues 302 with the same queue accumulation volume 310, the queue readout judgment unit 402 notifies the arbiter 311 of the queue number for a queue 302 as the subject of reading selected by the Round Robin or WRR method (step 839) so that the arbiter 311 outputs a read signal 304r to the queue 302 with the queue number determined by the queue readout judgment unit 402, reads an access request packet 304 out of the aforementioned queue 302 and carries out an access to the shared memory 314 (step 840).

If a plurality of queues 302 with the same queue accumulation volume 310 are judged not to exist in the above described step 838, the queue readout judgment unit 402 assigns a higher priority on the queue 302 with a larger queue accumulation volume 310 and notifies the arbiter 311 of the queue number for the aforementioned queue 302 (step 841). The arbiter 311 then outputs a read signal 304r to the queue 302 of the notified queue number, reads an access request packet 304 out thereof and carries out an access to the shared memory 314 (step 842).

The ensuing description is of a control method for a processing sequence of packets at the arbiter 311 according to the above described present embodiment and a transition of accumulation volume of access request packets 304 at the individual queues 302 during such processing while comparing with the case of applying a conventional technique.

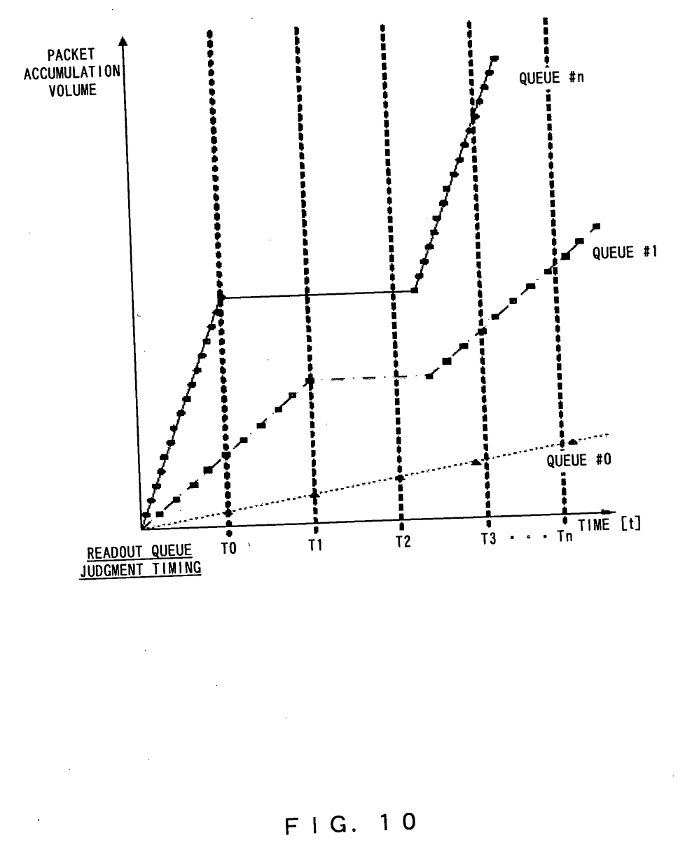

FIG. 10 shows variation on a time scale (i.e., accumulation volumes of access request packets 304 at individual queues 302 at each timing T0 through Tn), of incoming access request packets 304 to the individual of a plurality of queues 302 (i.e., queues #0, #1 and #n in this case) from the respective of a plurality of call control processors 301 (i.e., call control processors #0, #1 and #n in this case).

That is, FIG. 10 shows how the individual queues 302 receive the access request packets 304, in which the queue #0 sees a pattern of the incoming access request packets 304 at a certain low rate; the queue #1 sees a repeating pattern of burst traffic occurrence of incoming access request packets 304 followed by an incoming stop thereof for a certain period of time; and the queue #n sees a repeating pattern of high burst traffic occurrence of incoming access request packets 304 followed by an incoming stop thereof for a certain period of time. Let this exemplify an operating state of the case in which the individual queues 302 receive the access request packets 304 by the above described patterns.

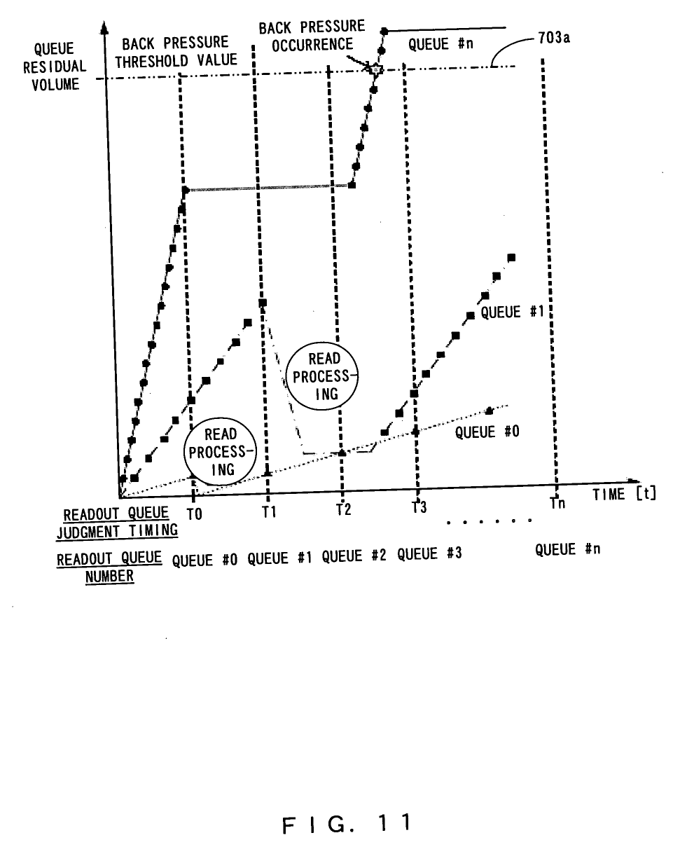

In such an operating state, if the arbiter 311 arbitrates a readout sequence for access request packets 304 by using the conventional Round Robin method as shown by FIG. 11, the readout processing is performed for a queue 302 containing an access request packet 304 in that sequence. That is, a certain volume of access request packets 304 is read out of a queue 302 at each readout queue judgment timing, i.e., the queue #0 at the timing T0, queue #1 at the timing T1, and queue #n at the timing Tn.

As a result of the above, the queue #n has not been processed at the timings of T0 through T3, leaving the access request packets 304 inputted thereto by a burst traffic unprocessed for reading, the accumulation volume at the aforementioned queue #n exceeding a back pressure occurrence threshold value (i.e., the setup value of 703a) and therefore outputting a back pressure signal 317 to the call control processor #n corresponding to the aforementioned queue #n. The aforementioned call control processor #n accordingly stops transmitting an access request packet 304 to the queue #n, resulting in bringing about a reduced processing capacity of the call control processor #n. As the number of call control processors 301 increases, so does the number of corresponding queues 302, extending the interval of reading the individual queues 302, and therefore making the possibility of outputting a back pressure signal 317 higher.

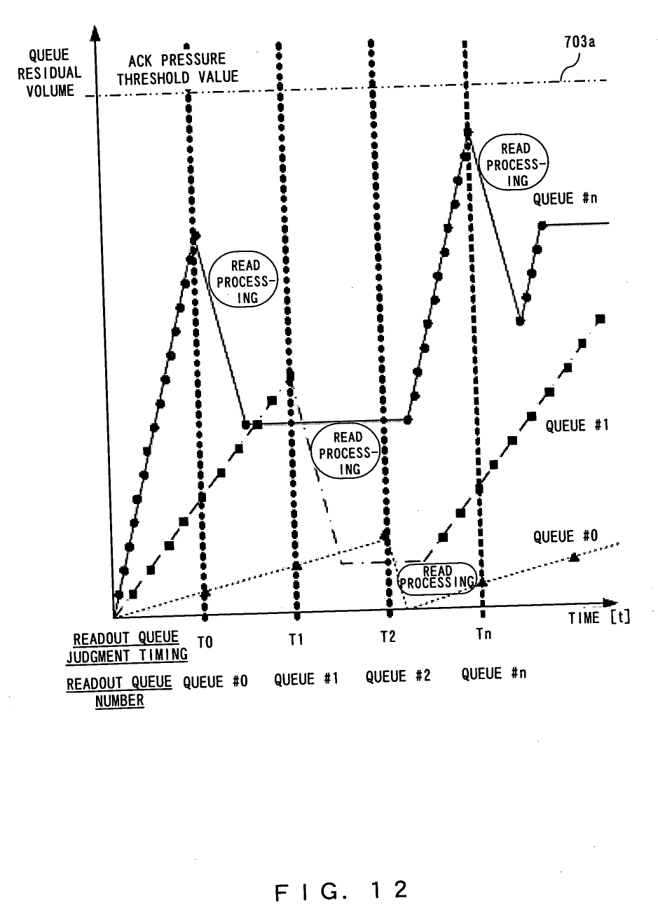

In the case of the present embodiment shown by FIG. 12 on the other hand, the accumulation speed calculation unit 308 comprised by each queue 302 measures an accumulation speed 309, and the accumulation speed comparison unit 401 and queue readout judgment unit 402 control the arbiter 311 so that a queue 302 with a higher accumulation speed 309 is prioritized for reading access request packets 304 out thereof. Therefore, if the queue accumulation volume 310 rapidly increases at the judgment timings T0, T1 or T2 as a result of burst traffic, a queue 302 with the highest accumulation speed 309 (i.e., the queue #n in this event) will be processed for reading the access request packets 304 with higher priority.

In the case of the present embodiment in other words, reading, in higher priority, the access request packets 304 out of the queue #n with a higher accumulation speed 309 anew caused by an occurrence of burst traffic in the timings T0 through T3 prevents the queue accumulation volume 310 from exceeding a setup threshold value 703a, resulting in avoiding the transmission of a back pressure signal 317 beforehand, which would have been transmitted in association with the conventional Round Robin method, and also degradation in the processing capacity of the call control processor #n corresponding to the queue #n.

As described thus far, the mobile communication control apparatus 100 according to the present embodiment brings forth the benefits as follows.

That is, the present embodiment is configured to carry out an access to the shared memory 314 by reading an access request packet 304 out of a queue 302 with a higher accumulation speed 309 in a higher priority, thereby preventing an occurrence of a back pressure signal 317 and suppressing a stoppage of receiving access request packets 304 at the aforementioned queue 302, that is, a delay of call processing control by each call control processor 301 during traffic concentration such as during a disaster occurrence in which performance degradation due to multiple occurrences of a back pressure signal 317 could not have been avoided by a conventional method such as the Round Robin method. This predicts an improvement in response, such as calling and receiving, to the user of mobile equipment.

In other words, the call processing control apparatus 300 is enabled to carry out accurate call processing without bringing about performance degradation such as discarding calls and processing stoppage.

Processing of access request packets 304 of the queue 302 with a higher accumulation speed 309 of a higher priority by measuring them for the individual queues 302, makes it possible to eliminate a time lag in transition to priority control of the processing sequence according to the condition of each queue and a need to increase the capacity of each queue 302 unnecessarily in order to accommodate a temporary buildup of accumulation volume at the time of burst traffic. This makes it possible to eliminate a circuit and a number of components for constituting each queue 302, thereby reducing production cost of the mobile communication control apparatus 100 and reducing product size.

In other words, it becomes possible to respond to a rapid increase in the number of call processes without unnecessarily increasing the capacity of a queue 302 for distributed call processing by a plurality of call control processors 301.

Also, if there is a large number of queues 302 for distributed call processing by a plurality of call control processors 301, it is possible to respond to a rapid increase in the number of call processes without being influenced by the number of installed queues 302.

Furthermore, the pieces of information such as accumulation speed 309 and queue accumulation volume 310 relating to each queue 302 obtained by the arbiter control unit 312 and, further, a readout queue number 318a, can be outputted to a maintenance-use console 352, waveform measurement instrument 360, et cetera, by way of the register 315 to enable monitoring of the status of priority processing at the arbiter 311, thereby empowering a mobile communication system including the mobile communication control apparatus 100 to analyze a cause at the time of a fault occurrence.

Note that while the above description exemplifies the case of measuring an accumulation speed 309, which is an accumulation volume of access request packets 304 at each queue 302 per unit of time, for the arbiter 311 to achieve control, the temporal change of accumulation speed 309 at each queue 302, that is, accumulation acceleration, may be measured for use in the control by the arbiter 311.

It goes without saying that the present invention is in no way limited by the examples put forth by the above described embodiments but can be changed variously within the scope of the present invention.

According to the present invention, it is possible to carry out accurate call processing without bringing about performance degradation such as discarding calls or processing stoppage.

It is also possible to respond to a rapid increase in the number of call processing without increasing the capacity of queues unnecessarily for distributed call processing by a plurality of processors.

It is further possible to respond to a rapid increase in the number of call processing if there is a large number of queues for distributed call processing by a plurality of processors.

What is claimed is:

1. A call processing control apparatus comprising:
a plurality of processors for carrying out a call control for communications;
a shared memory, being shared by a plurality of the processors, for retaining a call control data;
a plurality of queues, being equipped between each of the processors and the shared memory, for accumulating, in time series, access request information from the processor to the shared memory;
an accumulation speed measurement unit for measuring an accumulation speed which indicates an accumulation volume of the access request information in each of the queues per unit of time; and
an arbitration unit for determining which of the queues the access request information is to be taken out of to carry out an access to the shared memory.

2. The call processing control apparatus according to claim 1, wherein
said arbitration unit carries out access to said shared memory by taking out said access request information by selecting said queue in a descending sequence of said accumulation speed, or by taking the access request information out of the queue in a descending sequence of accumulation volume thereof if a plurality of the queues with the same accumulation speed exist.

3. The call processing control apparatus according to claim 1, wherein
said arbitration unit carries out an access to said shared memory by taking said access request information out of said queue in a prescribed sequence if a plurality of the queues with the same accumulation speed and accumulation volume exist.

4. The call processing control apparatus according to claim 1, wherein
said accumulation speed measurement unit comprises a timer for measuring a certain interval with an arbitration interval of said arbitration unit as reference, and
a counter for counting the number of said access request information at said queue within a time of the certain interval.

5. The call processing control apparatus according to claim 1, further comprising
an output interface for outputting a communication load status at each of said queue based on said accumulation speed to an external apparatus.

6. A control method for a call processing control apparatus including a plurality of processors for carrying out a call control for communications; a shared memory, being shared by a plurality of the processors, for retaining a call control data; and a plurality of queues, being equipped between each of the processors and the shared memory, for accumulating, in time series, access request information from the processor to the shared memory; comprising:
the first process of measuring an accumulation speed which indicates an accumulation volume of the access request information in each of the queues per unit of time; and
the second process of taking the access request information out of each queue to carry out an access to the shared memory in a descending sequence of the accumulation speed.

7. The control method for a call processing control apparatus according to claim 6,
carrying out an access to said shared memory by taking said access request information out of said queue in a descending sequence of said accumulation volume of the access request information in said second process, if a plurality of the queues with the same accumulation speed exist, in said second process.

8. The control method for a call processing control apparatus according to claim 6,
carrying out an access to said shared memory by taking said access request information out of said queue in a prescribed sequence, if a plurality of the queues with the same accumulation speed and accumulation volume exist, in said second process.

9. A mobile communication control apparatus including a first line terminal unit which is connected to a plurality of base stations for carrying out communications with mobile terminals, a second line terminal unit which is connected to a public line, and a call processing control unit, which intervenes between the first and second line terminal units, for carrying out call control, wherein
the call processing control unit comprises
a plurality of processors for carrying out a call control for communications;
a shared memory, being shared by a plurality of the processors, for retaining call control data;
a plurality of queues, being equipped between each of the processors and the shared memory, for accumulating, in time series, access request information from the processor to the shared memory;
an accumulation speed measurement unit for measuring an accumulation speed which indicates an accumulation volume of the access request information in each of the queues per unit of time; and
an arbitration unit for determining which of the queues the access request information is to be taken out of to carry out an access to the shared memory based on the accumulation speed at each of the queues.

10. The mobile communication control apparatus according to claim 9, wherein
said arbitration unit carries out an access to said shared memory by taking out said access request information by selecting said queue in a descending sequence of said accumulation speed, or by taking the access request information out of the queue in a descending sequence of accumulation volume thereof if a plurality of the queues with the same accumulation speed exist.

11. The mobile communication control apparatus according to claim 9, wherein
said arbitration unit carries out an access to said shared memory by taking said access request information out of said queue in a prescribed sequence if a plurality of the queues with the same accumulation speed and accumulation volume exist.

12. The mobile communication control apparatus according to claim 9, wherein
said accumulation speed measurement unit comprises a timer for measuring a certain interval with an arbitration interval of said arbitration unit as reference, and a counter for counting the number of said access request information at said queue within a time of the certain interval.
